(19) United States
(12) Patent Application Publication
(10) Pub. No.: US 2005/0092669 A1
(43) Pub. Date: May 5, 2005

(54) Filter cartridge and process for the production thereof

(75) Inventors: Ralf Ascher, Alfdorf (DE); Georg Schnieder, Bad Kreuznach (DE); Nicolaj Schmid, Waldstetten (DE)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hills, NY (US)

(21) Appl. No.: 10/953,069

(22) Filed: Sep. 30, 2004

Related U.S. Application Data
(63) Continuation of application No. PCT/EP03/05890, filed on Jun. 5, 2003.

(30) Foreign Application Priority Data
Jun. 5, 2002 (DE) 102 24 878.8

(51) Int. Cl. B01D 24/00

(52) U.S. Cl. 210/193; 210/266; 210/502.1; 210/483

(57) ABSTRACT

A filter cartridge including a porous layer of specific thickness wherein the layer exhibits a structure which has progressively smaller pore sizes, as measured in the direction of flow, and filter aids are incorporated in the porous layer and are introduced into, and anchored in, the porous layer by means of preconditioning, is disclosed.

This application is a continuation application of international application No. PCT/EP03/05890 filed Jun. 5, 2003, which is incorporated herein by reference in its entirety and for all purposes.

### BACKGROUND OF THE INVENTION

The invention relates to a filter cartridge of a material resistent to chemicals and water and to a process for the production thereof.

In many industrial fields use is made of precoat and cake filtration, particularly in the food industry, brewing industry, chemical and pharmaceutical industries, and the bioprocess industry. The filters used for this purpose are frequently filter candles mounted in a tank-like housing either standing on, or suspended from, a false bottom. EP 0 032 228 A2 describes the use of porous filter tubes in precoat candle-type filters. These filter tubes are made up of particles sintered together and consisting of a high-molecular plastics substance resistent to chemicals and water. In order to avoid rapid blocking due to penetration of the precoat into the pores of the porous filter tubes, the filter cartridge has low porosity on its inflow side, an arrangement which also makes for easier cleaning, since the precoat layer or the filter cake can be more readily removed by backwashing during the cleaning operation.

In filtration processes in which both the filtered liquid and the filter cake are desirable products, the use of filter aids is not possible because the presence of filter aid in the cake is undesirable. This excludes the use of the filter cake as a product.

### SUMMARY OF THE INVENTION

It is an object of the present invention to provide a filter cartridge, with the aid of which the downtime to commencement of filtration is shortened and by means of which two filtering actions can be carried out simultaneously. A further object of the invention is to provide a process for the production of such a filter cartridge.

This object is achieved with a filter cartridge having the features of claim 1, and by a process having the features of claim 11.

An advantage of the present invention is that the pore size of the filter cartridge diminishes progressively from the non-filtrate side toward the filtrate side. The incorporation of a filter aid in the pores of the porous layer makes it possible to commence filtration without precoating so that the time hitherto required for precoating is saved. Due to the fact that the incorporated filter aid is incorporated in the material, all succeeding filtrations can be carried out without any necessity for precoating. Blocking of the filter cartridge by particles and constituents of the non-filtrate takes place extremely slowly so that the service life of the filter cartridge between two cleaning cycles can be prolonged. Furthermore, the economics of a filtering plant are significantly improved, since the filter cartridge can be used to execute two filtration actions simultaneously, for example, precoat filtration and trapping filtration.

The incorporation of the filter aid in the pores of the porous layer provides a retaining effect and fixes already the particles of the filter aid in the porous layer to a considerable extent without performing a separate specific fixation step.

In a number of applications it may be desirable to fix the filter aid in the pores in a separate fixing or anchoring step.

Another advantage resides in the fact that, by reason of the filter aid incorporated in the pores, no contamination of the filter cake takes place, since filter cake and filter aid are kept separate from one another as a result of which the filter cake can be used as a product.

It is regarded as being particularly advantageous to provide the filter aids in a region which, measured in the direction of flow through the filter cartridge, is equal to not more than two-thirds of the thickness of the layer, beginning at the inflow or non-filtrate side. This depth of two-thirds of the thickness results in an adequate amount of filter aid being taken up by the pores so as to create the same conditions as could hitherto have been achieved only with an appropriate amount of precoat. The pore size in the porous layer is preferably from 0.5μ to 100μ, and the pores are occupied by the filter aids with the result that particles or ingredients of the non-filtrate are prevented from being absorbed by the pores.

The filter aid to be used can be selected, during production of the filter cartridge, in accordance with the desired filtration process or the intended use of the filter cartridge. Alternatively, a mixture of various filter aids may be provided, such as activated carbon, adsorbents, and resins. Furthermore, it is possible to additionally include and optionally fix a stabilizer such as silica gel, bentonite, or PVPP, which has the important advantage that three filtering actions can be carried out at the same time using one filter cartridge.

The material of which the filter cartridge is made is preferably a plastics material, particularly selected from the group consisting of a polypropylene, polyethylene, polyamide, polysulfone, polyether sulfone, polyetherfluoroethylene, and fiberglass-reinforced polypropylene, since these materials have hitherto been used with success for filter candles.

As an alternative to plastics material, use may be made of natural fibers or metals. Depending on the stability of the material, the geometrical design of the filter cartridge and the operating pressure to be expected, it may be advantageous to provide a supporting structure on the outflow side of the layer. Said supporting structure shows adequate permeability for the filtrate so that said structure itself provides no appreciable resistance to fluid flow. A particularly preferred embodiment of the filter cartridge is one in which the porous layer is in the form of a tubular body capable of forming a filter candle. In the case of a filter candle, the wall thickness of the tubular body or the thickness of the layer should be at least 0.05 times the diameter of the candle. In the case of filter candles of no great diameter, it is advantageous when the wall thickness ranges from 0.2 to 0.35 times the diameter.

There are various ways of introducing the filter aid into the porous layer, a particularly suitable method being to feed the filter aid into the porous layer by means of a liquid or a gaseous fluid.

A working example of the invention is explained below in greater detail with reference to the drawings.

### BRIEF DESCRIPTION OF THE DRAWINGS

FIG. 1 is a cross-section of a portion of a filter cartridge on an enlarged scale; and

FIG. 2 is a longitudinal cross-section of the filter cartridge of the invention in the form of a filter candle.

### DETAILED DESCRIPTION OF THE INVENTION

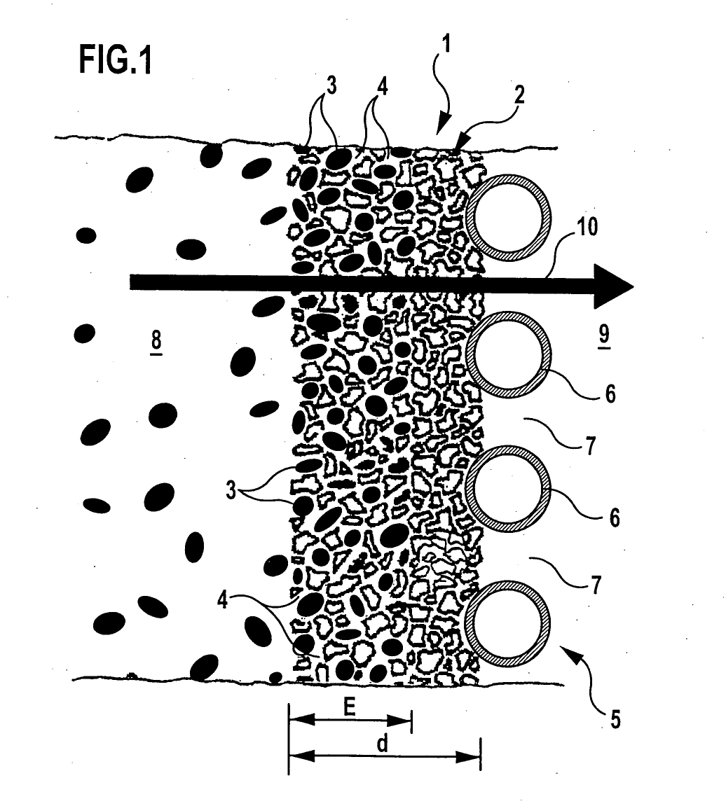

FIG. 1 shows, on an enlarged scale, a portion of a filter cartridge 1 consisting of a porous layer 2 of polymeric material. This polymeric material is preferably a polypropylene, of which the particles are sintered together or fused in such a manner that the porous layer 2 is formed so as to contain pores 4. The porous layer 2 is formed in such a manner that the pore size decreases in the direction of flow, as indicated by the arrow 10, i.e., from a non-filtrate side 8 progressively toward a filtrate side 9. On the filtrate side 9 of the porous layer 2 there is disposed a supporting element 5 comprising ribs 6 with intermediate passages 7. In some of the pores 4 formed within the porous layer 2, a filter aid 3 is included and retained, the introduction of said filter aid being effected from the non-filtrate side 8. Since the size of the pores 4 decreases in the direction of the arrow 10 and the possibility of incorporation of filter aid is determined by the pore size, the depth of penetration E of the filter aid 3 in the porous layer 2 is restricted. In the working example shown, the depth of penetration E is equal to approximately two-thirds of the thickness d of the porous layer 2.

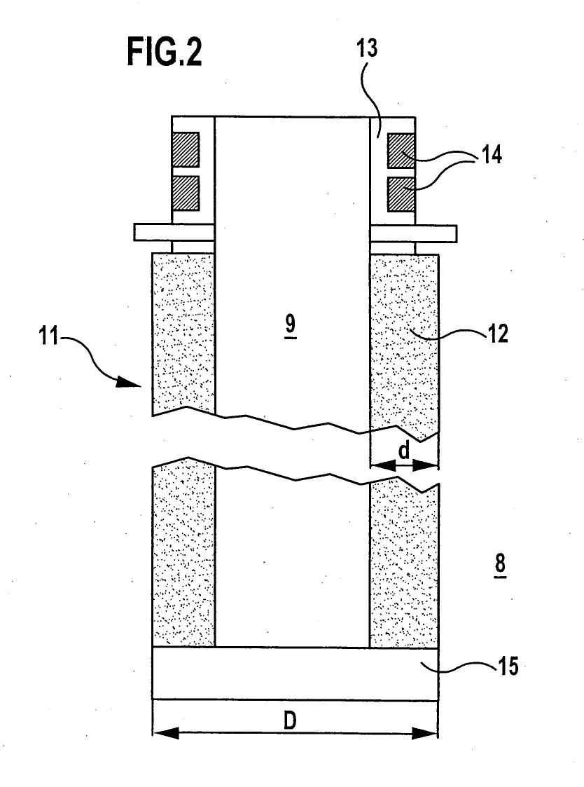

FIG. 2 shows a filter candle 11 substantially comprising a tubular body 12, whose structure corresponds to the porous layer 2 containing pores 4 with incorporated filter aid 3, as illustrated in FIG. 1. The filter candle 11 possesses a candle base 13 to allow it to be mounted on a support plate or an appropriate terminator or the like, packing rings 14 being provided on the candle base 13. At the other end of the tubular body 12 comprising the filter candle 11 there is disposed a terminating plate 15, which hermetically seals this end of the tubular body 12, thus separating the non-filtrate side 8 from the filtrate side 9. In the embodiment shown in FIG. 2, the thickness d of the porous layer 2 or the wall thickness of the tubular body 12 is such that it is equal to approximately 0.23 times the diameter D of the tubular body 12. A particularly suitable range of the ratio of wall thickness d to diameter D we regard as being from 1:3 to 1:5.

The filter cartridge described above affords, by reason of the particles of filter accelerator retained (and optionally additionally fixed or anchored) in the porous layer (deep-bed filtration layer), the possibility of carrying out precoat filtration without precoating. This leads to considerable saving of time and expense and to the completely novel possibility of carrying out two or even three filtering actions concurrently in a single filter.

The filter aid can be provided with the filter aid prior to the insertion of the filter cartridge into a filter housing, i.e., it can be supplied and installed as a complete unit. On the other hand, it is alternatively possible to install the unit consisting of the porous layer into a filter housing and to carry out the incorporation and fixation of the filter aid and, optionally, stabilizer prior to the first start-up or first filtration operation. For this purpose, filter aid is fed by means of a metering pump via a closed-loop water circuit to the porous layer, in which it is embedded and anchored. Filtration can commence immediately after the filter housing has been emptied. Further conditioning of the filter cartridge is not necessary.

1. A filter cartridge of a material resistant to chemicals and water, comprising a porous layer of a predefined thickness (d), formed by bonding, the layer having a structure showing a progressively decreasing pore size, as measured in the direction of flow, and comprising at least one filter aid incorporated in the porous layer, the filter aid being disposed in the porous layer by preconditioning.

2. The filter cartridge of claim 1, wherein the filter aid is fixed or anchored in the pores of said layer.

3. The filter cartridge as defined in claim 1, having an inflow side, wherein said filter aid is, as viewed in the direction of flow through the filter cartridge, disposed in a region measuring not more than two-thirds of the thickness (d) of the porous layer, beginning at the inflow side.

4. The filter cartridge as defined in claim 1, wherein the pore sizes in the porous layer range from 0.5 μm to 100 μm.

5. The filter cartridge as defined in claim 1, wherein the porous layer comprises a mixture of filter aids.

6. The filter cartridge as defined in claim 1, wherein stabilizing means are additionally incorporated in the porous layer.

7. The filter cartridge as defined in claim 1, wherein activated carbon, adsorbents, and/or resins are incorporated in the porous layer.

8. The filter cartridge as defined in claim 1, wherein the material is a polymeric material selected from polypropylene, polyethylene, polyamide, polysulfone, polyether sulfone, polyetherfluoroethylene and fiberglass-reinforced polypropylene.

9. The filter cartridge as defined in claim 1, wherein the material used is a metal.

10. The filter cartridge as defined in claim 1, wherein a supporting structure is disposed on the outflow side of the porous layer.

11. The filter cartridge as defined in claim 1, wherein the porous layer is in the form of a tubular member forming a candle filter.

12. The filter cartridge as defined in claim 11, having a diameter (D) and wherein the tubular member has a wall thickness that defines the thickness (d) of the porous layer and is equal to at least 0.05 times the diameter (D) of the cartridge.

13. The filter cartridge as defined in claim 12, wherein the wall thickness or thickness (d) ranges from 0.2 to 0.35 times the diameter (D).

14. A process for the production of a filter cartridge consisting of a material resistant to chemicals and water, in which particles of the material are bonded to form a porous layer of predefined thickness, such that the pore sizes progressively decrease in the direction of flow of the liquid to be filtered, wherein at least one filter aid is fed to the porous layer and incorporated by preconditioning in the pores of the porous layer.

15. The process as defined in claim 14, wherein the filter aid is fixed or anchored in the pores of the porous layer.

16. The process as defined in claim 14, wherein the filter aid is fed to the porous layer with the aid of a liquid.

17. The process as defined in claim 14, wherein the filter aid is fed to the porous layer with the aid of a gaseous fluid.
